(19) United States
(12) Patent Application Publication
(10) Pub. No.: US 2017/0347124 A1
(43) Pub. Date: Nov. 30, 2017

(54) METHOD OF ENCODING VIDEO PICTURE, METHOD OF DECODING VIDEO PICTURE, APPATATUS FOR ENCODING VIDEO PICTURE, APPARATUS FOR DECODING VIDEO PICTURE AND COMPUTER PROGRAM PRODUCT

(71) Applicant: THOMSON LICENSING, Issy les Moulineaux (FR)

(72) Inventors: Kai XIE, BEIJING (CN); Fei LU, BEIJING (CN)

(21) Appl. No.: 15/537,929

(22) PCT Filed: Dec. 22, 2014
(86) PCT No.: PCT/CN2014/094479

§ 371 Date: Jun. 20, 2017

(51) Int. Cl. H04N 19/66; H04N 19/176; H04N 19/166; H04N 19/159; H04N 19/119; H04N 19/44; H04N 19/105

(52) U.S. Cl. CPC H04N 19/66; H04N 19/44; H04N 19/176; H04N 19/105; H04N 19/159; H04N 19/119; H04N 19/166

(57) ABSTRACT

A method of encoding a video picture includes dividing an original picture into a plurality of picture parts S1; selecting different reference pictures for the respective picture parts; carrying out inter prediction of the picture parts using the respective reference pictures selected in the selecting; and dispersing data acquired based on the inter prediction in packets in such a manner that encoded slices of the data corresponding to one of the picture parts will be included in one of the packets and encoded slices of the data corresponding to another of the picture parts will be included in another of the packets S71.

### FIELD

The disclosure generally relates to a method of encoding a video picture, a method of decoding a video picture, an apparatus for encoding a video picture, an apparatus for decoding a video picture and a computer program product.

### BACKGROUND

Recently, the popularity of video applications on mobile devices, video conferences, VOD, live video broadcasting, and so forth, has been drastically increasing. However, a wireless channel may be error-prone and a packet loss may be commonplace. A packet loss may cause a decoding error and/or a perception of severe quality degradation. Therefore, there is a demand to minimize such quality degradation due to a data loss.

### SUMMARY

According to one aspect of the disclosure, a method of encoding a video picture includes dividing an original picture into a plurality of picture parts; selecting different reference pictures for the respective picture parts; carrying out inter prediction of the picture parts using the respective reference pictures selected in the selecting; and dispersing data acquired based on the inter prediction in packets in such a manner that encoded slices of the data corresponding to one of the picture parts will be included in one of the packets and encoded slices of the data corresponding to another of the picture parts will be included in another of the packets.

Other objects, features and advantages of the disclosure will become more apparent from the following detailed description when read in conjunction with the accompanying drawings.

### BRIEF DESCRIPTION OF THE DRAWINGS

FIG. 1 illustrates one example of a method of dividing a picture according to one embodiment of the present invention;

FIG. 2 illustrates one example of predicting blocks included in a current picture using respective blocks included in different pictures (as reference pictures) determined according to respective random minimal distances (RMDs) according to the embodiment;

FIG. 3 is a block diagram illustrating a configuration of an encoder according to the embodiment;

FIG. 4 is a flowchart illustrating operations in the encoder illustrated in FIG. 3;

FIG. 5 is a block diagram illustrating a configuration of a decoder according to the embodiment;

FIG. 6 is a flowchart illustrating operations in the decoder illustrated in FIG. 5; and

FIG. 7 is a block diagram of a computer applicable to implement each of the encoder of FIG. 3 and the decoder of FIG. 5.

### DESCRIPTION OF EMBODIMENT

According to the embodiment of the present invention, the following three steps (1), (2) and (3) are carried out by an encoder.

(1) While encoding a picture with an inter-prediction technique, the original picture is divided into some parts based on some rules. The thus acquired parts will be referred to as “subbands”, hereinafter. Each subband is down sampled from the original picture. The specific rules will be described later using FIG. 1.

(2) The slices encoded from the different subbands are transmitted in different packets to reduce the probability of all the subbands being lost at the same burst.

(3) During a motion estimation (ME) process, the encoder generates a random minimal distance (RMD) for each one of the subbands and ensures different RMDs for the different subbands. As a result, when the blocks in a subband are processed, another picture is used which has a greater distance from the current picture than the RMD of this subband as a reference picture only. The calculation of the RMD will be described later.

As a result of the step (3) being carried out in encoding, while decoding a block whose reference picture is lost, the data can be interpolated with neighboring blocks. Because the respective neighboring blocks belong to different subbands and the reference pictures of these blocks are different and are transmitted separately, the probability of all of these reference pictures being lost is low.

One example of dividing an original picture into some subbands in the step (1) is as follows.

1) The number (N, i.e., the “dividing number”) of subbands is determined based on an estimated channel condition. Commonly, a worse channel condition requires more subbands.

2) The block B(x,y) is allocated to the subband S(i) based on (x+y) mod N. FIG. 1 shows an example where N=5. In FIG. 1, different numbers (i.e., “0”, “1”, “2”, “3” and “4”) put in the respective squares (representing respective blocks) represent the corresponding subbands. Thus, in the example of FIG. 1, the picture is divided into the 5 subbands, i.e., a subband including the blocks numbered “0”, a subband including the blocks numbered “1”, a subband including the blocks numbered “2”, a subband including the blocks numbered “3” and a subband including the blocks numbered “4”.

Because burst and random are two main features of packet losses in a wireless channel, a key point of the present embodiment is that highly correlated data is not transmitted at the same packet or even at neighboring packets. In the present embodiment, the residual and motion vectors (MVs) of a current block, the reference of the current block and the data of neighboring blocks are transmitted in different packets with some separation distance. Thereby, if part of data is lost during transmission, there is other data that can be used to conceal the error as much as possible.

An RMD mentioned above in the description of the step (3) is determined in such a manner that an RMD is sufficiently large as to be able to deal with a possible burst loss. For example, an RMD is determined to be greater than an average distance between two adjacent burst losses. For example, an RMD is “8” or more if the average distance between two adjacent burst losses is “7” in a specific channel. Each of RMDs of respective subbands can be determined in a random manner but meets the condition of greater than or equal to “8”. Note that the actual “distance” can be measured by, for example, the number of pictures (frames) inserted between a current picture and its reference picture.

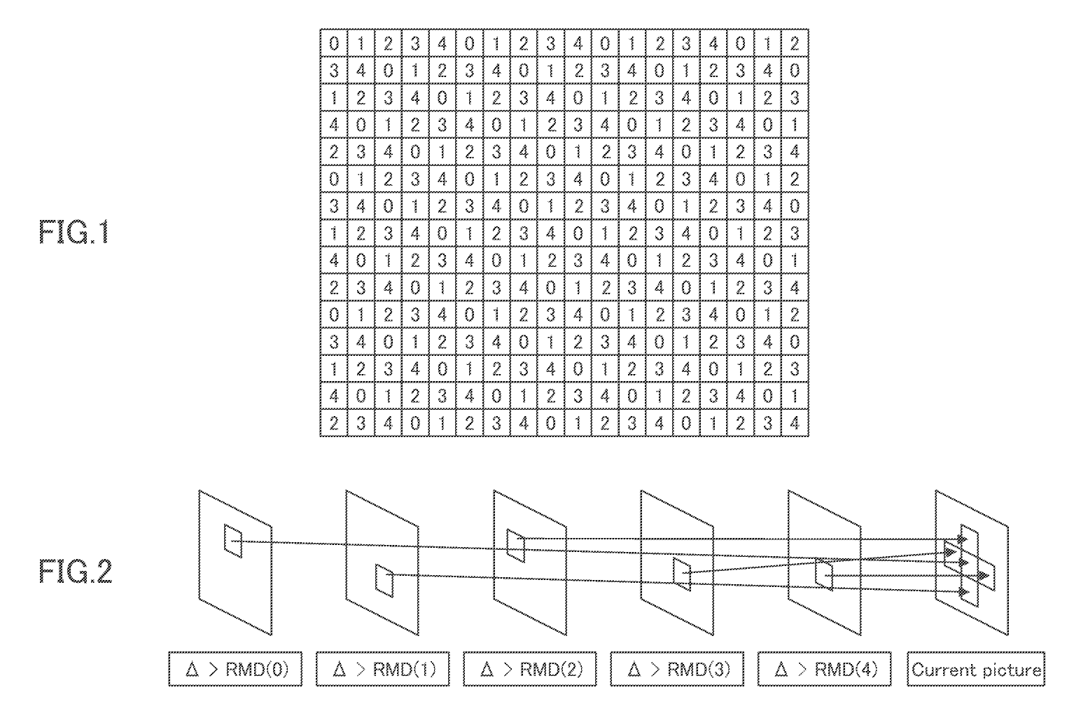

FIG. 2 illustrates one example of predicting blocks included in a current picture using respective blocks included in different pictures (as reference pictures) determined according to respective RMDs.

In the example of FIG. 2, for convenience of explanation, only five blocks in the current picture are shown.

As shown in FIG. 2, when one of the blocks is to be predicted, a reference picture is determined to have a distance Δ (>RMD(0)) from the current picture. Assuming that the block to be predicted belongs to a subband S(0), the RMD(0) is generated therefor in the above-mentioned step (3). Then, the block is predicted by using a predetermined block of the thus determined reference picture not belonging to the subband S(0).

Similarly, when another of the blocks is to be predicted, another reference picture is determined to have a distance Δ (>RMD(1)) from the current picture. Assuming that the block to be predicted belongs to a subband S(1), the RMD(1) is generated therefor in the above-mentioned step (3). Then, the block is predicted by using a predetermined block of the thus determined reference picture not belonging to the subband S(1). Thus, when one of the blocks is to be predicted, a reference picture is determined to have a distance Δ (>RMD(i)) (where i=0, 1, 2, . . . , N) from the current picture. Assuming that the block to be predicted belongs to a subband S(i), the RMD(i) is generated therefor in the above-mentioned step (3). Then, the block is predicted by using a predetermined block of the thus determined reference picture not belonging to the subband S(i).

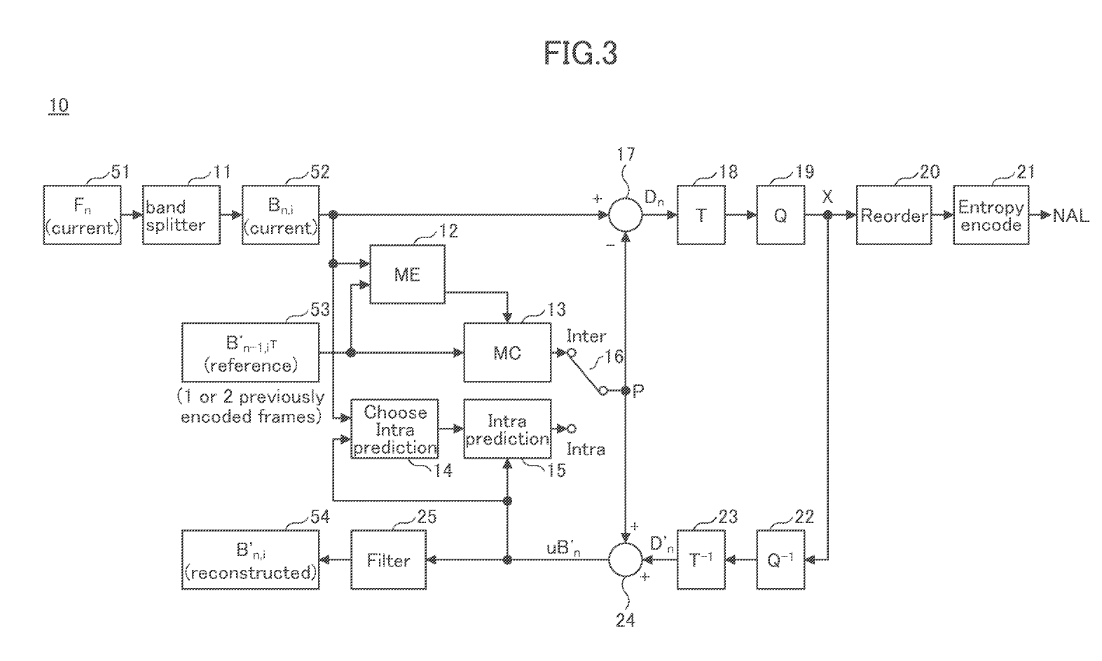

Next, using FIG. 3, one example of an encoder according to the present embodiment will be described.

As shown in FIG. 3, an encoder 10 includes a band splitter 11, a motion estimator (ME) 12, a motion compensator (MC) 13, a “Choose Intra prediction” module 14, an intra predictor 15, a changeover switch 16, a subtractor 17, a transformer (T) 18, a quantizer (Q) 19, a reorder module 20, an entropy encoder 21, an inverse quantizer (Q⁻¹) 22, an inverse transformer (T⁻¹) 23, an adder 24 and a filter 25.

An n-th frame (i.e., a current picture) 51 in a given video sequence is divided into subbands by the band splitter 11 as described above as the step (1) to acquire blocks 52 of an i-th subband S(i) (where i=1, 2, 3, . . . , N).

Each block 52 of the subband S(i) has a predicted block subtracted by the subtractor 17 to acquire a residual Dₙ.

The transformation block 18 and the quantizer 19 carry out a transformation process and a quantization process on the thus acquired residual Dₙ to acquire data X.

The inverse quantizer 22 and the inverse transformer 23 carry out an inverse quantization process and an inverse transformation process on the residual Dₙ. The adder 24 adds the prediction to the thus acquired residual D′ₙ to acquire the reconstructed block uB′ₙ.

The filter 25 carries out a filtering process on the reconstructed block uB′ₙ and the thus acquired reconstructed block 54 is stored to be used as a reference block(s) B′_{n-1,i}^{T} 53 for an inter-prediction process of another frame carried out by the motion estimator 12 and the motion compensator 13.

The motion estimator 12 carries out a ME process including a process of finding the reference block B′_{n-1,i}^{T} 53 (of a reference picture) from the subbands of the previously encoded frame(s) (F′ₙ₋₁) except the current subband S(i) in the manner described above for the step (3) (to meet the condition of RMD) to predict the current block. The motion compensator 13 carries out a MC process of acquiring a predicted block based on the result of the ME process.

The Choose Intra prediction module 14 selects intra prediction or inter prediction according to a standard rule, for example, a rule defined in a video coding standard such as MPEG2, MPEG4, AVC, or HEVC.

The Intra predictor 15 carries out an intra-prediction process of the current block 52 using the reconstructed block uB′ₙ not belonging to the current subband S(i), when the Choose Intra prediction module 14 selects intra prediction.

The changeover switch 16 selects the intra-predicted block P that is output from the Intra predictor 15 when the Choose Intra prediction module 14 selects intra prediction. The changeover switch 16 selects the inter-predicted block P that is output from the motion compensator 13 when the Choose intra prediction module 14 selects inter prediction.

After all the subbands of the current frame have been thus processed, the thus acquired data is processed by the reorder module 20.

Besides reordering the P pictures to the front of the B pictures, which is the standard function of the reorder module in a video coding standard such as MPEG2, MPEG4, AVC, or HEVC, the reorder module 20 carries out dispersing the data X in such a manner that the encoded slices (that are output from the entropy encoder 21) from the different subbands will be included in different packets.

The entropy encoder 21 carries out an entropy encoding process of the data of the current frame thus processed by the reorder module 20 and the entropy encoded data is transmitted in a form of NAL units (i.e., packets).

The other components and the other functions of the above-described components can belong to a standard video encoder.

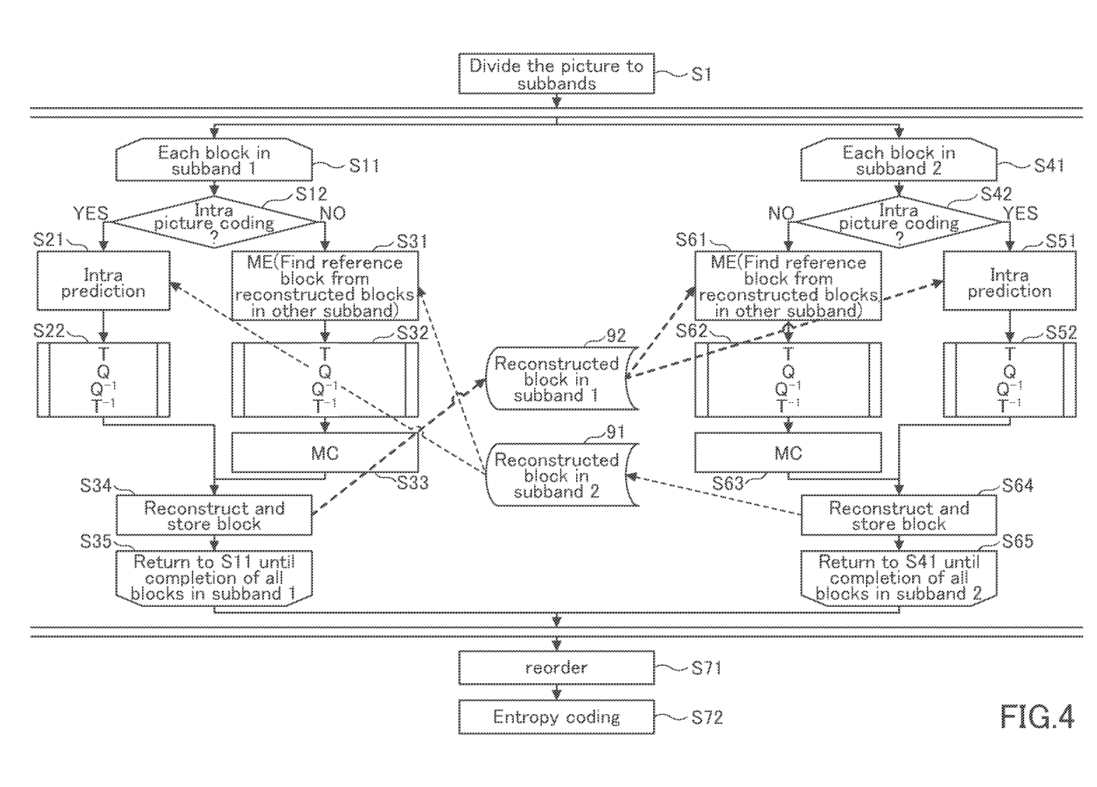

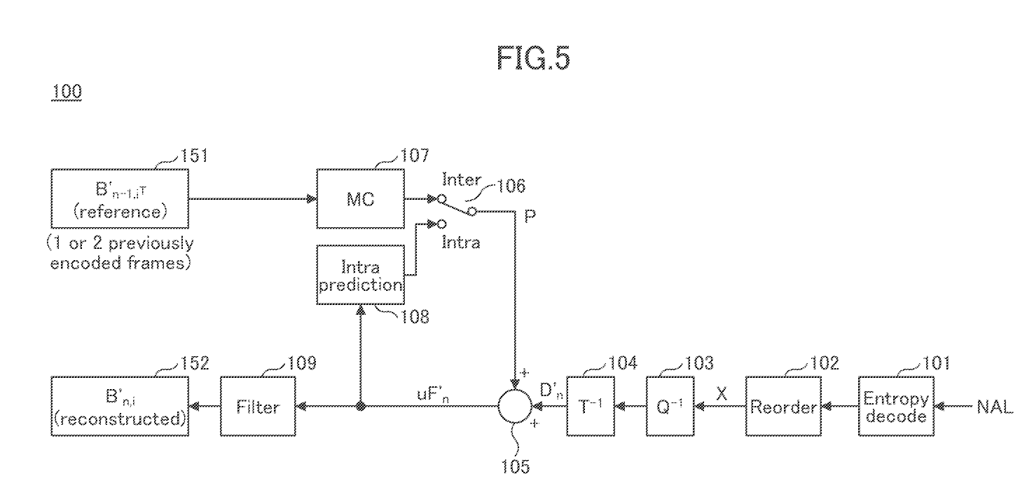

Next, using FIG. 4, operations of the encoder 10 according to the present embodiment will be described.

In Step S1, the current picture (frame) is divided into a plurality of subbands by the band splitter 11. In the example of FIG. 4, the dividing number N is 2. The subbands 1 and 2 are determined based on a specific pattern (see FIG. 1, for example).

Each block in each of the subbands 1 and 2 is encoded according to a standard compression algorithm, except that a block(s) in the other subband(s) is(are) referenced during the intra-prediction process and an ME process in the inter-prediction process.

Thus, a compressed bitstream is constructed.

In more detail, in Steps S11 and S41, each block in each of the subbands 1 and 2 is processed in sequence.

In Steps S12 and S42, for each of the subbands 1 and 2, intra prediction or inter prediction is selected according to the predetermined rule by the Choose Intra prediction module 14. When intra prediction is selected, the process proceeds to Step S21 and S51. When inter prediction is selected, the process proceeds to Step S31 and S61.

In Step S21, an intra-prediction process is carried out by the Intra predictor 15 using a reconstructed block 91 belonging to the subband 2. In Step S51, an intra-prediction process is carried out by the Intra prediction block 15 using a reconstructed block 92 belonging to the subband 1.

In each of Steps S22 and S52, a transformation process, a quantization process, an inverse quantization process and an inverse transformation process are carried out based on the data acquired from the corresponding one of Steps S21 and S51 by the transformer 18, the quantizer 19, the inverse quantizer 22 and the inverse transformer 23.

In Step S31, a ME process including a process of finding a reference block 91 (of a reference picture) from the subband 2 of the previously encoded frame(s) is carried out by the motion estimator 12 in the manner described above for the step (3) (to meet the condition of RMD) to predict the current block. In Step S61, a ME process including a process of finding a reference block 92 (of a reference picture) from the subband 1 of the previously encoded frame(s) is carried out by the motion estimator 12 in the manner described above for the step (3) (to meet the condition of RMD) to predict the current block.

In each of Steps S32 and S62, a transformation process, a quantization process, an inverse quantization process and an inverse transformation process are carried out on the data, acquired from the corresponding one of Steps S31 and S61, by the transformer 18, the quantizer 19, the inverse quantizer 22 and the inverse transformer 23.

In each of Step S33 and Step S63, a MC process of acquiring a predicted block is carried out by the motion compensator 13 based on the result of the ME process of the corresponding one of Steps S31 and S61.

In each of Steps S34 and S64, the current block is reconstructed and stored according to a standard process, and will be used for intra prediction of a subsequent block or inter prediction of a subsequent frame (picture).

In each of Steps S35 and S65, the process returns to the corresponding one of Steps S11 and S41 until all the blocks in the corresponding one of the subbands 1 and 2 have been processed.

In Step S71, the data of all the blocks of the subbands 1 and 2 of the current picture (frame) acquired from the transformation process and the quantization process in Steps S22, S32, S52 and S62 are reordered by the reorder module 20 in the manner described above. Thus, besides reordering the P pictures to the front of the B pictures, which is the standard function of the reorder module in a video coding standard such as MPEG2, MPEG4, AVC, or HEVC, the data are dispersed in such a manner that the encoded slices from the different subbands 1 and 2 will be included in different packets. In other words, the encoded slices from the subband 1 will be included in a certain packet(s) while the encoded slices of the subband 2 will be included in the other packet(s), for example.

In Step S72, the thus processed data of the current picture is entropy encoded by the entropy encoder 21.

Note that a specific method of selecting a reference block not belonging to a current subband to be used to predict a current block can be such that, if the reference block to be used to predict the current block belongs to the current subband according to a standard process, the nearest block belonging to another subband can be selected, for example.

Next, as shown in FIG. 5, one example of a decoder according to the present embodiment will be described.

As shown in FIG. 5, the decoder 100 includes an entropy decoder 101, a reorder module 102, an inverse quantizer (Q⁻¹) 103, an inverse transformer (T⁻¹) 104, an adder 105, a changeover switch 106, a motion compensator (MC) 107, an intra predictor 108 and a filter 109.

The entropy decoder 101 receives given data. The data can be of a form of NAL units (i.e., packets) and output data of the encoder 10 described above and in FIG. 3. The entropy decoder 101 carries out an entropy decoding process of the data of a form of NAL units (i.e., packets) after parsing it.

The reorder module 102 reorders the data processed by the entropy decoder 101 into the original order to acquire data X corresponding to an original picture.

The inverse quantizer 103 and the inverse transformer 104 carry out an inverse quantization process and an inverse transformation process on a block included in the thus acquired data of the original picture to acquire a residual D′ₙ.

The adder 105 adds the residual D′ₙ and a predicted block P to acquire a block of a current frame uF′ₙ.

The filter 109 carries out a filtering process to acquire a reconstructed block B′_{n,i} 152.

The motion compensator 107 carries out a MC process using the reference block(s) B′_{n-1,i}^{T} 151 from the subbands of the previously encoded frame(s) except the current subband S(i) as in the encoder 10 described above.

The intra predictor 108 carries out an intra-prediction process using a reference block not belonging to the current subband S(i) as in the encoder 10 described above.

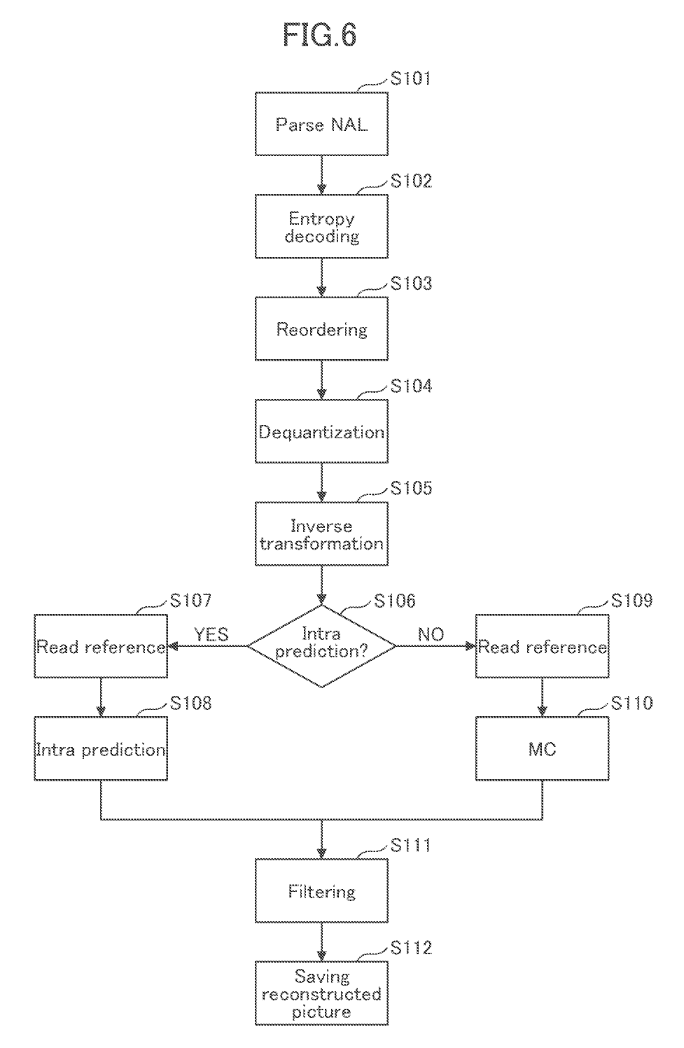

Next, using FIG. 6, operations of the decoder 100 according to the present embodiment described above will be described.

In Step S101, given data is received and parsed. The data can be of a form of NAL units (i.e., packets) and output data of encoding process described above and in FIG. 4.

In Step S102, the parsed data is entropy encoded by the entropy decoder 101.

In Step S103, the entropy encoded data is reordered into the original order to acquire data corresponding to an original picture by the reorder module 102.

In Step S104, a block included in the reordered data is inverse quantized by the inverse quantizer 103.

In Step S105, the inverse quantized block is inverse transformed by the inverse transformer 104 to acquire a residual.

In Step 106, intra prediction or inter prediction is selected according to whether intra prediction or inter prediction was selected when the current block was encoded. When intra prediction is selected, the process proceeds to Step S107. When inter prediction is selected, the process proceeds to Step S109.

In Step S107, the reference block is read which is not included in the current processed subband as in the encoding process described above.

In Step S108, an intra-prediction process is carried out by the intra predictor 108 using the thus read reference block.

In Step S109, the reference block(s) is(are) read from the subbands of the previously encoded frame(s) except the current subband as in the encoding process described above.

In Step S110, a MC process is carried out by the motion compensator 107 using the thus read reference block(s).

In Step S111, a filtering process is carried out by the filter 109 on the thus acquired block.

In Step S112, the thus acquired block is saved as a block included in a reconstructed (decoded) picture.

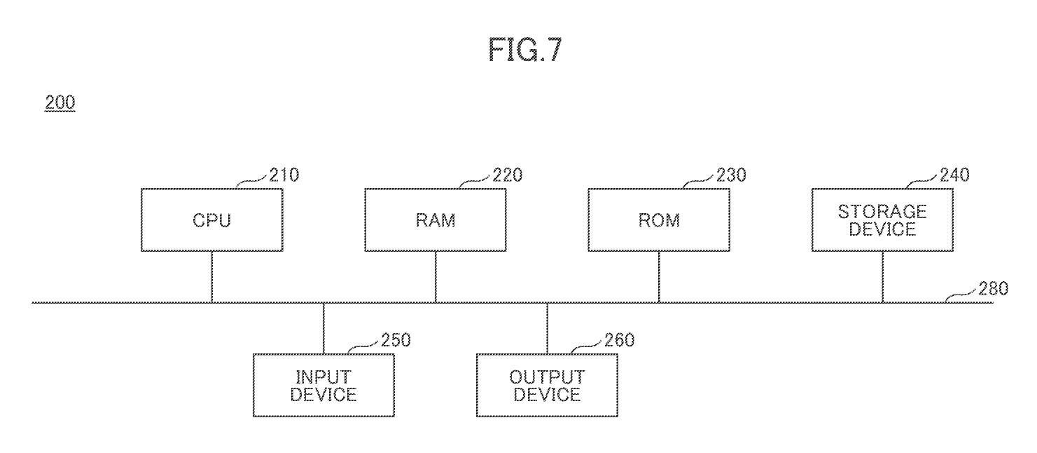

Each of the encoder 10 described above using FIGS. 3 and 4 and the decoder 100 described above using FIGS. 5 and 6 can be implemented by a computer. FIG. 7 is a block diagram of a computer applicable to implement each of the encoder 10 of FIG. 3 and the decoder 100 of FIG. 5.

As shown in FIG. 7, the computer 200 includes a Central Processing Unit (CPU) 210, a Random Access Memory (RAM) 220, a Read-Only Memory (ROM) 230, a storage device 240, an input device 250 and an output device 260 which are connected via a bus 280 in such a manner that they can carry out communication thereamong.

The CPU 210 controls the entirety of the computer 200 by executing a program loaded in the RAM 220. The CPU 210 also performs various functions by executing a program(s) (or an application(s)) loaded in the RAM 120.

The RAM 220 stores various sorts of data and/or a program(s).

The ROM 230 also stores various sorts of data and/or a program(s).

The storage device 240, such as a hard disk drive, a SD card, a USB memory and so forth, also stores various sorts of data and/or a program(s).

The input device 250 includes a keyboard, a mouse and/or the like for a user of the computer 200 to input data and/or instructions to the computer 200.

The output device 260 includes a display device or the like for showing information such as a processed result to the user of the computer 200.

The computer 200 performs the process described above using FIG. 4 or the process described above using FIG. 6 as a result of the CPU 210 executing instructions written in a program(s) loaded in the RAM 220, the program(s) being read out from the ROM 230 or the storage device 240 and loaded in the RAM 220.

Thus, the method of encoding a video picture, the apparatus for encoding a video picture, the method of decoding a video picture, the apparatus for decoding a video picture and the computer program product have been described by the specific embodiment. However, the present invention is not limited to the embodiment, and variations and replacements can be made within the scope of the claimed invention.

1. A method of encoding a video picture comprising the steps of:
dividing an original picture into a plurality of picture parts;
selecting mutually different reference pictures for the respective picture parts;
carrying out inter prediction of the picture parts using the respective reference pictures selected in the selecting; and
dispersing data acquired based on the inter prediction in packets in such a manner that encoded slices of the data corresponding to one of the picture parts will be included in one of the packets and encoded slices of the data corresponding to another of the picture parts will be included in another of the packets.

2. A method of decoding a video picture comprising the steps of:
reordering given data, which has been dispersed in such a manner that encoded slices of the data corresponding to one of picture parts divided from an original picture will be included in one of the packets and encoded slices of the data corresponding to another of the picture parts will be included in another of the packets, into an original order;
selecting mutually different reference pictures for the respective picture parts; and
carrying out inter prediction of the picture parts using the respective reference pictures selected in the selecting.

3. The method as claimed in claim 1, wherein
in the step of carrying out inter prediction, a picture part in the reference picture not corresponding to a current picture part is used to predict the current picture part.

4. The method as claimed in claim 1, wherein
the step of selecting includes a step of determining different minimum distances for the respective picture parts and selecting the respective reference pictures having the different minimum distances to the original picture.

5. The method as claimed in claim 4, wherein
each of the minimum distances is greater than an average distance between adjacent packet losses.

6. The method as claimed in claim 2, wherein
a dividing number N of dividing the original picture is determined to be greater as a condition of a channel to transmit the packets is worse and respective blocks of the original picture having coordinates x and y are allocated to the N picture parts according to a rule of (x+y) mod N.

7. The method as claimed in claim 1, wherein
the step of dividing includes a step of determining a dividing number N to be greater as a condition of a channel to transmit the packets is worse and allocating respective blocks of the original picture having coordinates x and y to the N picture parts according to a rule of (x+y) mod N.

8. An apparatus for encoding a video picture, the apparatus comprising:
means for dividing an original picture into a plurality of picture parts;
means for selecting different reference pictures for the respective picture parts;
means for carrying out inter prediction of the picture parts using the respective reference pictures selected in the selecting; and
means for dispersing data acquired based on the inter prediction in packets in such a manner that encoded slices of the data corresponding to one of the picture parts will be included in one of the packets and encoded slices of the data corresponding to another of the picture parts will be included in another of the packets.

9. An apparatus for decoding a video picture, the apparatus comprising:
means for reordering given data, which has been dispersed in such a manner that encoded slices of the data corresponding to one of picture parts divided from an original picture will be included in one of the packets and encoded slices of the data corresponding to another of the picture parts will be included in another of the packets, into an original order;
means for selecting different reference pictures for the respective picture parts; and
means for carrying out inter prediction of the picture parts using the respective reference pictures selected in the selecting.

10. The apparatus as claimed in claim 8, wherein
the means for carrying out inter prediction is configured to carry out inter prediction where a picture part in the reference picture not corresponding to a current picture part is used to predict the current picture part.

11. The apparatus as claimed in claim 8, wherein
the means for selecting is configured to determine different minimum distances for the respective picture parts and select the respective reference pictures having the different minimum distances to the original picture.

12. The apparatus as claimed in 11, wherein
each of the minimum distances is greater than an average distance between adjacent packet losses.

13. The apparatus as claimed in claim 9, wherein
a dividing number N of dividing the original picture is determined to be greater as a condition of a channel to transmit the packets is worse and respective blocks of the original picture having coordinates x and y are allocated to the N picture parts according to a rule of (x+y) mod N.

14. The apparatus as claimed in claim 8, wherein
the means for dividing is configured to determine a dividing number N to be greater as a condition of a channel to transmit the packets is worse and allocate respective blocks of the original picture having coordinates x and y to the N picture parts according to a rule of (x+y) mod N.

15. A computer program product downloadable from a communication network and/or recorded on a medium readable by a computer and/or executable by a processor, comprising program code instructions for implementing a method according to claim 1.

16. The method as claimed in claim 2, wherein
in the step of carrying out inter prediction, a picture part in the reference picture not corresponding to a current picture part is used to predict the current picture part.

17. The method as claimed in claim 2, wherein
the step of selecting includes a step of determining different minimum distances for the respective picture parts and selecting the respective reference pictures having the different minimum distances to the original picture.

18. The method as claimed in claim 17, wherein
each of the minimum distances is greater than an average distance between adjacent packet losses.

19. The apparatus as claimed in claim 9, wherein
the means for carrying out inter prediction is configured to carry out inter prediction where a picture part in the reference picture not corresponding to a current picture part is used to predict the current picture part.

20. The apparatus as claimed in claim 9, wherein
the means for selecting is configured to determine different minimum distances for the respective picture parts and select the respective reference pictures having the different minimum distances to the original picture.

21. The apparatus as claimed in 20, wherein
each of the minimum distances is greater than an average distance between adjacent packet losses.

22. A computer program product downloadable from a communication network and/or recorded on a medium readable by a computer and/or executable by a processor, comprising program code instructions for implementing a method according to claim 2.
